(19) United States
(12) Patent Application Publication
(10) Pub. No.: US 2024/0291786 A1
(43) Pub. Date: Aug. 29, 2024

(54) MANAGEMENT CONTROL MESSAGE ROUTING

(71) Applicant: Intel Corporation, Santa Clara, CA (US)

(72) Inventors: Janusz P. Jurski, Beaverton, OR (US); Mariusz Oriol, Gdynia (PL); Filip Schmole, Portland, OR (US)

(73) Assignee: Intel Corporation, Santa Clara, CA (US)

(21) Appl. No.: 18/660,020

(22) Filed: May 9, 2024

(51) Int. Cl. H04L 51/21; H04L 45/02

(52) U.S. Cl. CPC H04L 51/21; H04L 45/02

(57) ABSTRACT

A management control message is received to be routed from a first device to a second device in a system. The management control message is determined to include management control data. It is determined whether the second device supports such management control messages and it is determined whether to forward the management control message to the second device based on whether the second device supports management control messages. Management control messages are routed to destination devices within the system over a bridge device associated with the management control messages.

### FIELD

The present disclosure relates in general to computing systems, and more specifically, to routing vendor defined messages within a system.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (e.g., server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate fast communication. Further, as the demand for future high performance processors increases, demand grows for interconnect architectures capable of supporting the corresponding high data rates made available by next generation processors.

### BRIEF DESCRIPTION OF THE DRAWINGS

FIG. 1 illustrates a block diagram of an example computing system.

FIG. 2 illustrates an embodiment of a computing system including an interconnect architecture.

FIG. 3 illustrates an embodiment of a transmitter and receiver pair for an interconnect architecture.

FIG. 4 is a simplified block diagram of an example computing system with one or more management controllers.

FIG. 5 is a simplified block diagram illustrating example management control messaging networks.

FIGS. 6A-6B are simplified block diagrams illustrating example routing of management control messages within an example system.

FIG. 7 is a simplified flow diagram illustrating an example technique for routing management control messages within a system.

FIG. 8 illustrates an embodiment of a block diagram for a computing system including a multicore processor.

FIG. 9 illustrates another embodiment of a block diagram for a computing system.

Like reference numbers and designations in the various drawings indicate like elements.

### DETAILED DESCRIPTION

The subject matter disclosed herein relates to improving performance characteristics of point-to-point interconnects in computing platforms through improved sockers or connectors, such as card edge connectors. A card edge connector is a portion of a circuit board that includes contact fingers disposed on an outer surface of the circuit board and is configured to mate with a matching connector, which may be referred to herein as an edge connector socket or simply a “connector socket”, “socket”, or “slot”. Edge connectors may be included in a wide variety of electronic components, including memory chips, expansion cards, graphics cards, network interface cards, among others. Card edge connectors may be used to couple a component of a computer to a printed circuitry board used to implement a computing platform, such as a single-board computer (CBS), system host board (SHB), motherboard, or other PCB, which includes sockets configured to accept card edge connectors or other device connectors. Card edge connectors may also be included in add-in-cards that couple to a computer, such as a laptop, through an expansion slot. Card edge connectors and other connectors may also be used in server platforms, including blade servers, rack servers, towers servers, etc.

In some cases, the geometry of an edge connector and the connector socket may be dictated to some degree by an industry specification. For example, for a device compatible with a Peripheral Component Interconnect Express (PCIe) protocol, the edge connector and socket geometry may be dictated, in part, a corresponding protocol specification, such as the PCIe Special Interest Group (SIG) Card Electromechanical (CEM) Specification, among other examples. In some embodiments, the discussed pass-through connector device may incorporate a pair of connector sockets according to a PCIe-based protocol, such as a PCIe Gen 1, Gen 2, Gen 3, Gen 4, Gen 5, Gen 6 (e.g., PCIe 6.0 Specification, January 2022), Gen 7 or future PCIe protocol yet to be developed. Furthermore, although some example embodiments in the present disclosure may refer specifically to PCIe, it should be appreciated that an example pass-through connector device may incorporate connector elements of a variety of form factors and geometries defined in accordance with any suitable communication protocol, including PCI, PCIe, Universal Serial Bus (USB), Compute Express Link (CXL) (e.g., CXL Specification 3.1, published November 2020), Universal Chiplet Interconnect Express (UCIe) (e.g., UCIe Specification 1.1, July 2022), NVLink, UltraPath Interconnect (UPI), QuickPath Interconnect™ (QPI), DDR memory, and other proprietary or non-proprietary communication protocols.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other by means of electromagnetic coupling (e.g., a link that incorporates one or more intermediate devices over which the coupling of the two or more elements is accomplished).

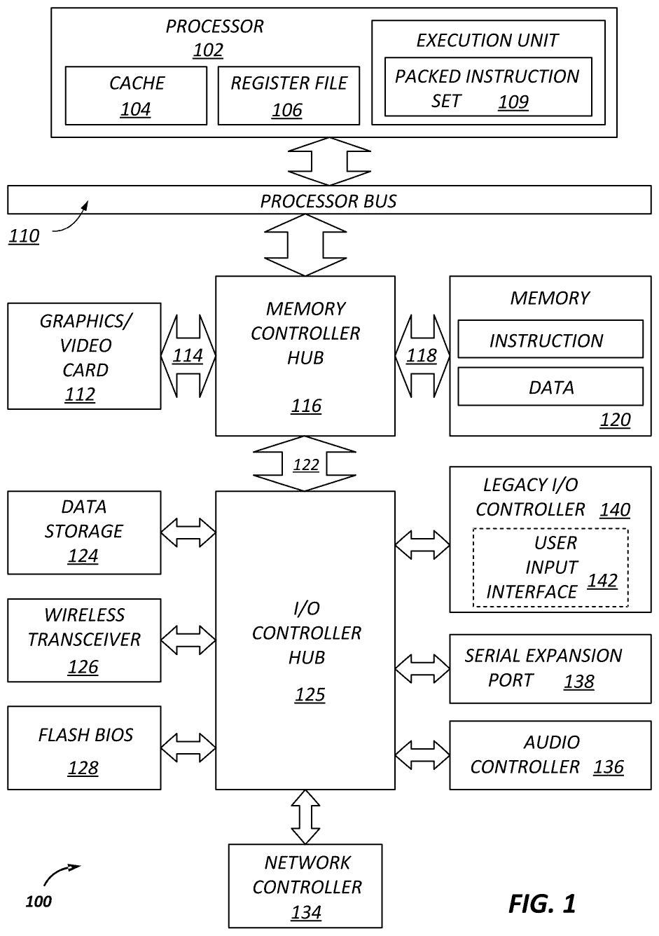

FIG. 1 is a block diagram of an example of a computer system, wherein one or more of the interconnects implement one or more features in accordance with embodiments described herein. As used herein, the term interconnect refers to any type of communicative coupling between components, including card edge connectors or other end devices, for example. The system 100 includes a component, such as a processor 102 to employ execution units including logic to perform algorithms for process data, in accordance with the present disclosure, such as in the embodiment described herein. System 100 is representative of processing systems based on the PENTIUM III™ PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In some implementations, system 100 may be implemented as a system-on-chip (SoC) device, with all or a portion of the components of system 100 provided on a same package or die. In embodiments, the system 100 executes an operating system, embedded software, and/or graphical user interfaces, may also be used. Thus, embodiments of the present disclosure are not limited to any specific combination of hardware circuitry and software.

Furthermore, embodiments are not limited to computer systems. Rather, embodiments of the present disclosure can be used in any suitable electronic devices that include edge connectors, including handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other suitable system.

The processor 102 can include one or more execution units 108 to implement an algorithm that is to perform at least one instruction. Although some embodiments may be described in the context of a single processor desktop or server system, embodiments may also be included in a multiprocessor system. System 100 is an example of a ‘hub’ system architecture. The computer system 100 includes a processor 102 to process data signals. The processor 102, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that transmits data signals between the processor 102 and other components in the system 100. In some implementations, elements of bus 110 or other interconnect for coupling elements of system 100 (e.g., graphics accelerator 112, memory controller hub 116, memory 120, I/O controller hub 125, wireless transceiver 126, Flash BIOS 128, network controller 134, audio controller 136, serial expansion port 138, I/O controller 140, etc.) may be implemented, at least in part, using one or more pass-through connector device. Features discussed herein, including routing of management control messages, may be implemented using such elements of an example system 100.

In one embodiment, the processor 102 includes a Level 1 (L1) internal cache memory 104. Depending on the architecture, the processor 102 may have a single internal cache or multiple levels of internal caches. Other embodiments include a combination of both internal and external caches depending on the particular implementation and needs. Register file 106 is to store different types of data in various registers including integer registers, floating point registers, vector registers, banked registers, shadow registers, checkpoint registers, status registers, and instruction pointer register.

Execution unit 108, including logic to perform integer and floating point operations, also resides in the processor 102. The processor 102, in one embodiment, includes a microcode (ucode) ROM to store microcode, which when executed, is to perform algorithms for certain macroinstructions or handle complex scenarios. Here, microcode is potentially updateable to handle logic bugs/fixes for processor 102. In some embodiments, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 108 may also be used in micro controllers, embedded processors, graphics devices, DSPs, and other types of logic circuits. The system 100 includes a memory 120. The memory 120 includes a dynamic random access memory (DRAM) device, a static random access memory (SRAM) device, flash memory device, or other memory device. The memory 120 stores instructions and/or data represented by data signals that are to be executed by the processor 102.

Note that an example pass-through connector device, such as discussed herein, may be utilized to implement two or more connectors associated with the interconnects shown in FIG. 1 or other systems described and shown herein, among other examples. For instance, a pass-through connector device may also be associated with the processor bus 110 (e.g., Intel Quick Path Interconnect (QPI) or other known high performance computing interconnect), a high bandwidth memory path 118 to memory 120, a point-to-point link to graphics accelerator 112 (e.g., a Peripheral Component Interconnect express (PCIe) compliant fabric), a controller hub interconnect 126, an I/O or other interconnect (e.g., USB, PCI, PCIe) for coupling the other illustrated components. Some examples of such components include the audio controller 138, firmware hub (flash BIOS) 134, wireless transceiver 132, data storage 130, legacy I/O controller 142 containing user input and keyboard interfaces 144, a serial expansion port 140 such as Universal Serial Bus (USB), and a network controller 136. The data storage device 130 can include a hard disk drive, a flash memory device, or other mass storage device.

It is to be understood that the block diagram of FIG. 1 is not intended to indicate that the computing system 100 is to include all of the components shown in FIG. 1. Rather, the computing system 100 can include fewer or additional components not illustrated in FIG. 1. Furthermore, the components may be coupled to one another according to any suitable system architecture, including the system architecture shown in FIG. 1 or any other suitable system architecture that uses card edge connectors to facilitate digital communications between components. For example, embodiments of the present techniques can also be implemented in any suitable electronic device, including ultra-compact form factor devices, such as System-On-a-Chip (SOC) and multi-chip modules.

A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

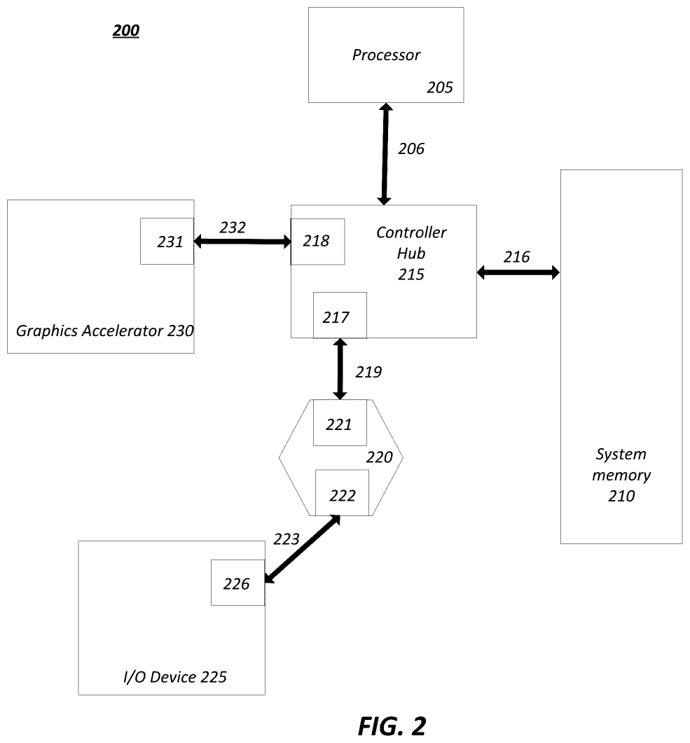

Referring to FIG. 2, an embodiment of a fabric composed of point-to-point Links that interconnect a set of components is illustrated. System 200 includes processor 205 and system memory 210 coupled to controller hub 215. Processor 205 includes any processing element, such as a microprocessor, a host processor, an embedded processor, a co-processor, or other processor. Processor 205 is coupled to controller hub 215 through front-side bus (FSB) 206. In one embodiment, FSB 206 is a serial point-to-point interconnect as described below. In another embodiment, link 206 includes a serial, differential interconnect architecture that is compliant with different interconnect standard.

System memory 210 includes any memory device, such as random access memory (RAM), non-volatile (NV) memory, or other memory accessible by devices in system 200. System memory 210 is coupled to controller hub 215 through memory interface 216. Examples of a memory interface include a double-data rate (DDR) memory interface, a dual-channel DDR memory interface, and a dynamic RAM (DRAM) memory interface.

In one embodiment, controller hub 215 is a root hub, root complex, or root controller in a PCIe interconnection hierarchy. Examples of controller hub 215 include a chipset, a memory controller hub (MCH), a northbridge, an interconnect controller hub (ICH) a southbridge, and a root controller/hub. Often the term chipset refers to two physically separate controller hubs, e.g., a memory controller hub (MCH) coupled to an interconnect controller hub (ICH). Note that current systems often include the MCH integrated with processor 205, while controller 215 is to communicate with I/O devices, in a similar manner as described below. In some embodiments, peer-to-peer routing is optionally supported through root complex 215. In some implementations, a pass-through connector device may be utilized for connections to root complex 215 to reduce the number of connections between the root complex and endpoint devices, reduce interconnect trace lengths, simplify complexity of the interconnect fabric, and reduce signal integrity loss, among other example benefits.

Here, controller hub 215 is coupled to switch/bridge 220 through serial link 219. Input/output modules 217 and 221, which may also be referred to as interfaces/ports 217 and 221, include/implement a layered protocol stack to provide communication between controller hub 215 and switch 220. In one embodiment, multiple devices are capable of being coupled to switch 220.

Switch/bridge 220 routes packets/messages from device 225 upstream, e.g., up a hierarchy towards a root complex, to controller hub 215 and downstream, e.g., down a hierarchy away from a root controller, from processor 205 or system memory 210 to device 225. Switch 220, in one embodiment, is referred to as a logical assembly of multiple virtual PCI-to-PCI bridge devices. Device 225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 225 may include a PCIe to PCI/PCI-X bridge to support legacy or other version PCI devices. Endpoint devices in PCIe are often classified as legacy, PCIe, or root complex integrated endpoints.

Graphics accelerator 230 is also coupled to controller hub 215 through serial link 232. In one embodiment, graphics accelerator 230 is coupled to an MCH, which is coupled to an ICH. Switch 220, and accordingly I/O device 225, is then coupled to the ICH. I/O modules 231 and 218 are also to implement a layered protocol stack to communicate between graphics accelerator 230 and controller hub 215. Similar to the MCH discussion above, a graphics controller or the graphics accelerator 230 itself may be integrated in processor 205.

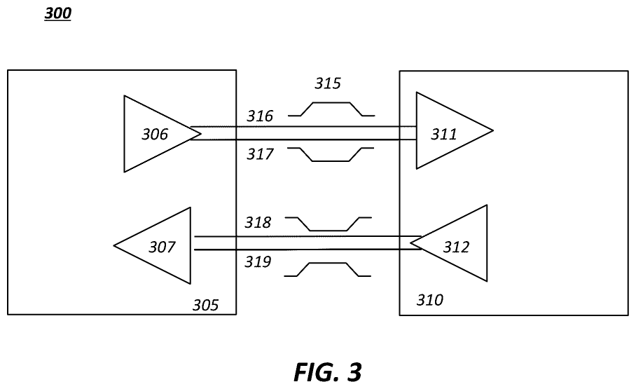

Referring next to FIG. 3, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 306/311 and a receive pair 312/307. Accordingly, device 305 includes transmission logic 306 to transmit data to device 310 and receiving logic 307 to receive data from device 310. In other words, two transmitting paths, e.g., paths 316 and 317, and two receiving paths, e.g., paths 318 and 319, are included in a PCIe link.

A transmission path refers to any path for transmitting data, such as a transmission line, a copper line, an optical line, a wireless communication channel, an infrared communication link, or other communication path. A connection between two devices, such as device 305 and device 310, is referred to as a link, such as link 315. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 316 and 317, to transmit differential signals. As an example, when line 316 toggles from a low voltage level to a high voltage level, e.g., a rising edge, line 317 drives from a high logic level to a low logic level, e.g., a falling edge. Differential signals potentially demonstrate better electrical characteristics, such as better signal integrity, e.g., cross-coupling, voltage overshoot/undershoot, ringing, etc. This allows for better timing window, which enables faster transmission frequencies.

PCIe and other interconnect protocols may support custom or specialized message formats to facilitate management of a system (e.g., management of various components or blocks of an SoC in connection with management controllers of the components) or other features. As one example, the Management Component Transport Protocol (MCTP) defines a communication model to facilitate communication between management controllers and managed devices or other management controllers. MCTP defines a message format, transport description, message exchange patterns, and configuration and initialization messages. While MCTP may be carried over PCIe, it may be potentially used with various bus types. For instance, MCTP may be used for intercommunication between elements of platform management subsystems used in computer systems (e.g., mobile, desktop, workstation, or server platforms).

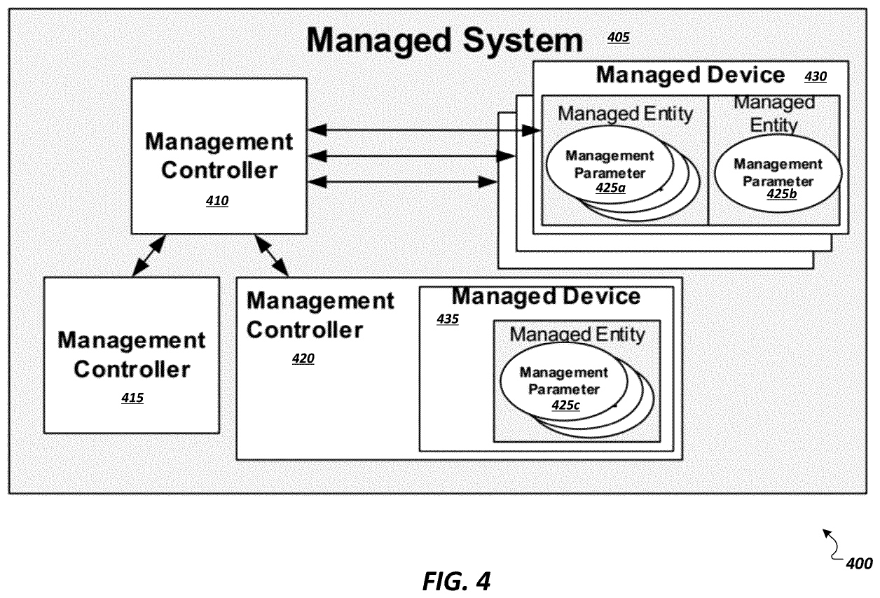

Turning to FIG. 4 is a simplified block diagram 400 illustrating an example managed system 405, which may utilize MCTP. Management controllers (e.g., 410, 415, 420) may include a microcontroller or processor that aggregates management parameter data (e.g., 425a-c) from one or more managed devices (e.g., 430, 435) and makes this data available for consumption by local or remote software. Management controllers may also interpret and process management-related data, initiate management-related actions on managed devices, and provide management-related information to software subsystems, among other examples. Management controllers (and related MCTP data) can be used to perform management related-actions including power management, control of address resolution handling, configuration of out-of-band management traffic, device authentication, interrupt handling, among other examples. In some implementations, management controllers (e.g., with a cloud computing or datacenter environment) may be virtualized by allowing multiple services, virtual machines or containers, or hosts (e.g., virtual machines) to share ownership of the management controllers (e.g., using single-root I/O virtualization (SR-IOV), Scalable I/O Virtualization (SIOV), or another example technique). Managed devices may refer to a device (e.g., a chip, card, IP block, etc.) that may be accessed via a bus messaging protocol (e.g., PCIe, CXL, etc.) by a management controller. Management parameter access provided by a managed device may be provided using an abstracted interface and data model rather than through direct “register level” accesses. An example of a management controller are baseboard management controllers (BMC).

Management controllers can use MCTP to send and receive MCTP-formatted messages across the different bus types that are used to access managed devices and other management controllers. Managed devices in a system provide an implementation of MCTP messages to facilitate actions performed by management controllers. MCTP endpoints are devices serving as a terminus or origin of MCTP packets or messages (e.g., a MCTP-capable management controllers or managed device). MCTP bridge devices may also be provided which can route MCTP messages not destined for themselves, which are received on one interconnect, by forwarding the MCTP messages onto another destination device without processing or interpreting the message prior to forwarding. The ingress and egress media at a bridge may be either homogeneous or heterogeneous.

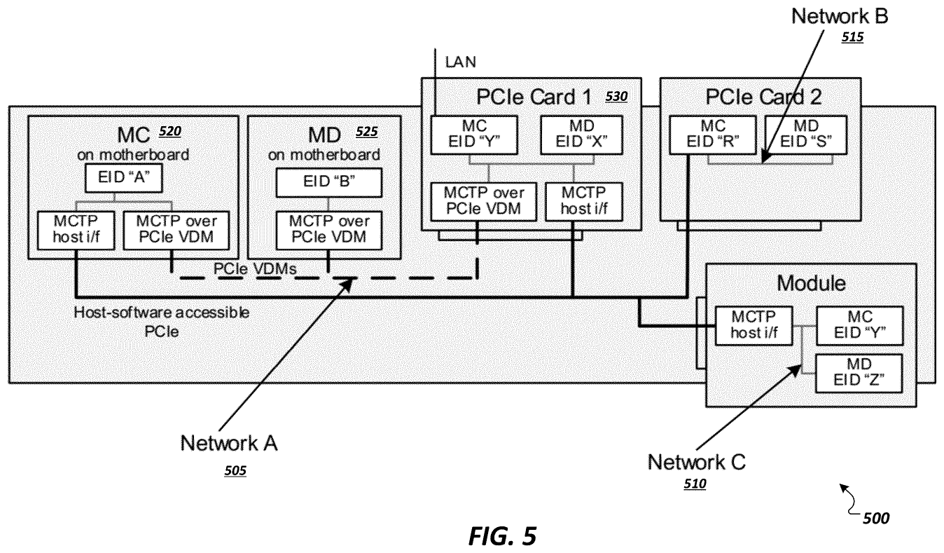

MCTP is a transport independent protocol that may be used for intercommunications within MCTP networks. An MCTP network may include one of more physical transports that are used to transfer MCTP messages between MCTP endpoints. MCTP Transport Binding Specifications define how the MCTP protocol is implemented across a particular physical transport medium. As examples, the DMTF has defined transport bindings for MCTP over SMBus/I2C and MCTP over PCIe using PCIe Vendor Defined Messages (VDMs), among other examples. Within an MCTP network, a physical device may provide one or more MCTP Endpoints. Endpoints may be addressed using a logical address called the Endpoint ID, or EID. EIDs in MCTP are analogous to IP Addresses in Internet Protocol networking. EIDs can be statically or dynamically allocated. As shown in the example illustrated in the simplified block diagram 500 of FIG. 5, system implementations may include or implement one or multiple MCTP networks. A MCTP network (e.g., 505, 510, 515) may include one or more devices including one or more management controllers and/or managed devices interconnected by buses supporting MCTP. In some instances, MCTP networks may have their own separate EID spaces. An MCTP network may provide an MCTP Network ID that can be used to differentiate between MCTP networks when more than one MCTP network can be accessed by an entity such as system software.

FIG. 5 shows that multiple different MCTP networks (e.g., 505, 510, 515) may be implemented within a system. For instance, in this example, Network A 505 connects a management controller (e.g., 520) and managed devices (e.g., 525) on a motherboard with devices on a PCIe card (e.g., 530) using MCTP over PCIe Vendor Defined Messages (VDMs). In this example, two host interfaces may be provided that can be used by host software to access this particular network 505. Accordingly, Network A may include an MCTP Network ID so that the host software can tell that the two host interfaces connect to the same MCTP network 505. Network B 510 represents a network that is solely used for interconnecting devices within a given device (e.g., PCIe card 535). MCTP network 510 may omit the use of an MCTP Network ID as it is not visible to host software or other entities that would need to differentiate Network B 510 from other MCTP networks (e.g., 505, 515) in the system. Network C 515 represents an MCTP Network on an add-in module. This network is separate from networks A and B but can be accessed by host software through PCIe. Thus, this network 515 utilizes a Network ID so that host software can differentiate that Network C 515 is a different network than Network A 505. MCTP messages may include one or more MCTP Packets. MCTP defines fields that support the assembly of received MCTP Packets into MCTP messages and the disassembly of MCTP messages into packets for transmission. MCTP is designed to be able to transfer multiple message types in an interleaved manner using the same protocol.

Not all devices in a system may support MCTP or another specialized, proprietary, customer, or vendor-defined protocol. Indeed, as systems become more modular, with multiple different vendors providing components for inclusion on a card, package, SoC, etc., the likelihood increases of one or more of the components lacking support of all of protocols supported by other components in the system. A protocol may define a non-disruptive mechanism for a device to reject a message according to a protocol (e.g., MCTP) not supported by the device. For instance, in PCIe, each device (e.g., IP block) in a system (e.g., an SoC) may be configured to silently discard VDMs (e.g., MCTP VCMs) they do not support as they arrive. The receiving device may recognize a message as pertaining to an unsupported protocol and perform this silent discard. The protocol may require more disruptive solutions (e.g., poison, crash, escalation, etc.) for other data received, which is unexpected or unrecognized by the device. While at least theoretically, a silent discard function may serve as a solution for the handling of unsupported messages (e.g., MCTP messages), it is a significant effort to implement and validate the exception handling of every possible message of the various protocols and subprotocols that may be supported on an interconnect (e.g., PCIe Type 1 MCTP VDMs by every PCIe IP of the SoC). For example, MCTP packets may carry a relatively long payload and the IP may only expect valid requests to carry four bytes of payload. In order to implement this special handling of MCTP packets, the IP implementation complexity would significantly increase. Indeed, validating silent discard behavior is expensive from the validation perspective and it may be even practically impossible to verify all the forms of vendor defined messages (e.g., MCTP packets), such as their lengths and payloads. Even if an inability to silently drop such packets is discovered during validation for certain types of packets or messages, this results in additional defect fixing costs. Some example architectures may be unable to implement smart MCTP packet filtering for peer-to-peer communication, in order to constrain the traffic to selected devices, such as BMC, PRoT, or IPU, among other examples.

As an example of silent discarding, the PCIe specification 6.0.1, section 2.2.8.6 “Vendor_Defined Messages”, defines that “Completers silently discard Vendor_Defined Type 1 Messages that they are not designed to receive—this is not an error condition”. For example, PCIe VDM Type 1 messages include MCTP and, as such, are to be silently discarded if the target device does not understand them per the PCIe specification. However, silent discard of such PCIe transactions is an exception from the behavior that PCIe endpoints (e.g., IP blocks) normally implement—they usually escalate unsupported requests, which may often lead to a systemwide impact, sometimes an intentional crash. Such a serious escalation is desired in some scenarios, but is not expected for MCTP packets. Further, PCIe, CXL, and other interconnects may enable or allow peer-to-peer traffic between devices on a network utilizing the interconnect protocol. For instance, peer-to-peer traffic is allowed on MCTP PCIe networks. However, peer-to-peer traffic of some messages, such as MCTP messages, which may result in the manipulation of management controller tasks, may introduce additional security risk. Peer-to-peer MCTP transactions may be considered risk and difficult to secure because a successful attack on one of the PCIe endpoints may open the door to a direct attack on other PCIe endpoints, among other example vulnerabilities. Accordingly, peer-to-peer MCTP message exchange may be subject to supervision to protect against rogue MCTP endpoints. Additionally, when one or more endpoints do not correctly handle silent discard of MCTP messages, a rogue endpoint could intentionally exploit this vulnerability to force undesirably crashes of the system, among other example issues impacting the adoption and implementation of MCTP on PCIe, CXL, and other communication fabrics.

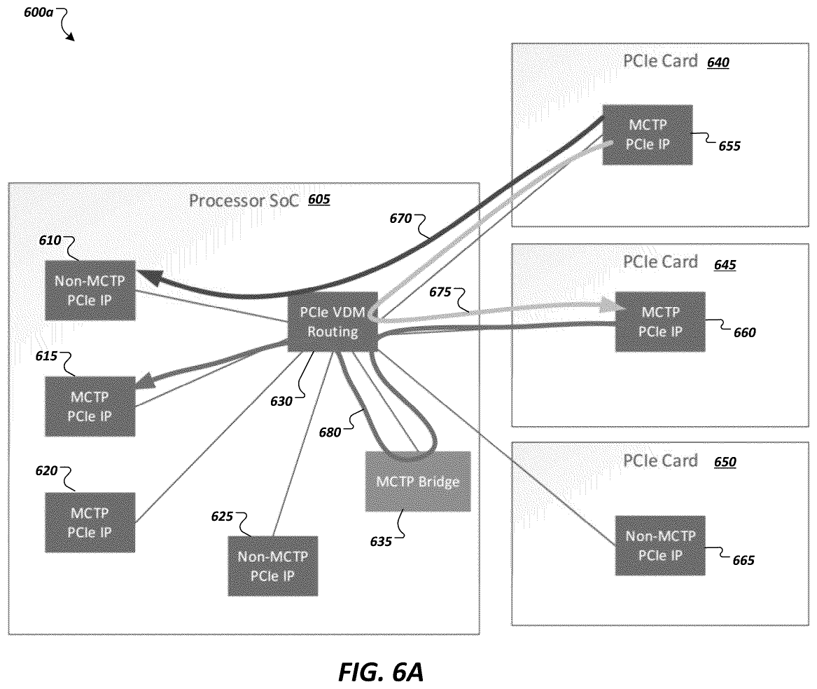

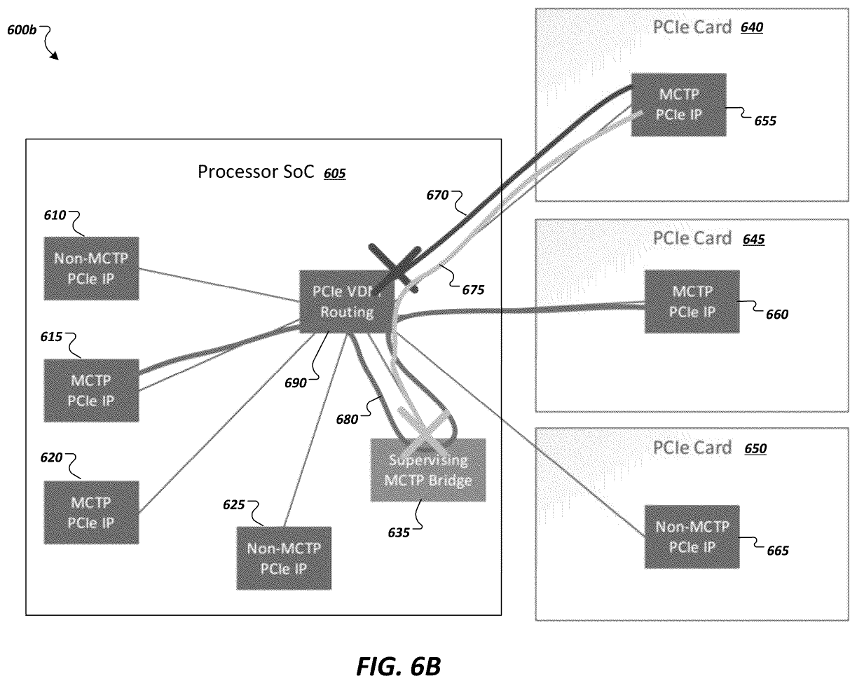

Turning to the simplified block diagram 600a of FIG. 6A, an example system architecture is shown including a processor system on chip (SoC) device 605, which includes various IP blocks (e.g., 610, 615, 620, 625, etc.), which may support PCIe-based communications over links interconnecting the IP blocks with a root complex, PCIe bridge, or other PCIe routing logic 630. In this example, a MCTP bridge block 635 may also be provided and may assist in routing MCTP messages to other devices (e.g., connected via alternate media or interconnect protocols, etc.). The SoC 605 may be coupled to one or more other devices, such as PCIe card devices 640, 645, 650, via respective PCIe links. In this example, these devices 640, 645, 650 may include additional IP blocks (e.g., 655, 660, 665), which may communicate with the SoC 605 (and the constituent IP blocks (e.g., 610, 615, 620, 625) of the SoC using respective PCIe links.

FIG. 6A illustrates various ways in which MCTP messages (or other VDM messages) may be routed within an example system. In a first example 670, an MCTP packet is sent from a MCTP IP block 655 on device 640 to another IP block 610 on the SoC 605. The MCTP packet is routed to the destination IP block 610 using VDM routing circuitry 630. This destination IP block 610, however, does not support MCTP, as such this peer-to-peer MCTP packet should be silently discarded by the IP block 610. However, a risk remains if non-MCTP IP block 610 fails to correctly identify that the MCTP packet is an unsupported VDM (e.g., due to unforeseen or imperfect implementation of discard logic at the IP block 610, etc.), but instead considers the packet as a disallowed or erroneous message or data format, causing the IP block 610 to initiate a crash or other escalation. As another example, another MCTP packet 675 may be sent from MCTP IP block 655 on device 640 to another PCIe card device 645 (e.g., to MCTP PCIe IP block 660). While both the sender (e.g., 655) and receiver (e.g., 660) both support MCTP, and this transaction may be successful, there may be instances where such peer-to-peer MCTP messaging may be undesirable from a security perspective (e.g., rogue PCIe endpoints trying to impersonate a management controller, devices (e.g., Smart NICs or host processors) bypassing platform security and executing unauthorized or malicious management commands, spoofing telemetry for side channel attacks, among other examples). In a third example, an MCTP packet 680 is sent from one MCTP-supporting IP block 660 on device 645 to another MCTP-supporting IP block (e.g., 615) on the SoC 605. In this example, VDM routing circuitry 630 routes the MCTP packet over MCTP bridge 635, although in other examples a simile MCTP packet may be routed between IP blocks 660 and 615 directly over the VDM routing circuitry 630, among other examples. This message 680 may be “legal” and acceptable in either case, given that the MCTP packet is sent between MCTP-supporting devices. Upon successful receipt of an MCTP packet, a management controller on the IP block (e.g., 615, 620, 655, 660, etc.) may perform one or more management-related tasks (e.g., collection of data describing attributes of a device, performing one or more management control actions at the device, etc.) and may generate a completion or other response (e.g., sharing of management parameter data, etc.) using a response MCTP message, among other examples.

In an improved implementation, enhanced routing circuitry 690 is provided for use within a system similar to that introduced within FIG. 6A. For instance, turning to the simplified block diagram 600b of FIG. 6B, routing circuitry 690 may be provided on an SoC 605. In other implementations, the routing circuitry 690 may be provided as a standalone device (e.g., on a separate card or package). Within a system, all traffic (e.g., PCIe traffic, CXL traffic, SMBus traffic, I2C traffic, etc.) may be configured to be routed through routing circuitry 690. The enhanced routing circuitry 690 may be configured to parse data (e.g., packets, flits, messages, etc.) to detect that the data includes particular VDM data, such as MCTP data. When messages are determined to include the particular VDM data, the routing circuitry 690 may force the messages to be routed to a bridge device (e.g., 635) configured to handle the particular VDM data. For instance, in the case of MCTP, the routing circuitry 690 may determine whether data to be routed is MCTP or not. If the data does not include MCTP data, the data is routed as normal (or according to other routing rules corresponding to its type). If the data is MCTP data, the routing circuitry 690 may automatically route the data to an MCTP bridge 635.

In the example of MCTP, functionality of an MCTP bridge 635 may be defined to such that the MCTP bridge acts as an MCTP network supervisor. In some implementations, multiple MCTP bridges may be provided within a system with multiple MCTP networks. Routing circuitry 690 may route MCTP messages to any one of the MCTP bridges. The enhanced routing circuitry 690 may alleviate risks associated with endpoints potentially not supporting MCTP (or another VDM format). For instance, as shown in the example of FIG. 6B, a peer-to-peer MCTP packet (e.g., 670) may be identified by the routing circuitry 690 as including MCTP data and may additionally identify (e.g., using a routing table that also identifies endpoints' MCTP support status) that the destination of the packet does not support MCTP. Rather than relying on the (potentially imperfect) ability of the non-MCTP IO block 610 to silently discard the packet, the routing circuitry 690 may itself silently discard the packet without forwarding the packet on to the non-MCTP destination device 610. This can prevent instances where a non-MCTP IP block that does not correctly implement the handling of unexpected MCTP packet causes an escalation or crash of the broader system based on the packet. As such, the enhanced routing circuitry 690 may effectively prohibit MCTP packets from being routed to non-MCTP endpoints.

Continuing with the example of FIG. 6B, an MCTP packet 675, which is technically correct (e.g., a MCTP IP-to-MCTP IP transaction (e.g., from IP block 655 to IP block 660)), but is an undesired or against a policy for security or other reasons (e.g., were the MCTP packet to be routed directly between the IP blocks 655, 660 and not over the MCTP bridge 635) may be blocked by logic of the MCTP bridge 635. The routing circuitry 690 may automatically cause the packet 675 to be routed over the MCTP bridge 635, despite identifying (e.g., from a routing table) that the destination of the packet 675 supports MCTP. The MCTP bridge 635 may perform deep packet inspection to perform routing that is enhanced (e.g., beyond traditional address-based or bus/device/function (BDF)-based routing) to consider policies or specialized rules (configured at the MCTP bridge), thereby allowing the MCTP bridge 635 to enforce policies, which would block such peer-to-peer MCTP packets. Other MCTP packets (e.g., 680), which are destined for an MCTP-supporting device (e.g., 615) and allowed (e.g., according to logic of the MCTP bridge 635), will also be forwarded onto the bridge 635 for successful delivery to the destination MCTP device (e.g., 615), among other examples.

By forcing all MCTP messages over an MCTP bridge and enhancing routing logic to silently discard any MCTP messages, which are destined to a non-MCTP-supporting device (e.g., 610, 625, 665, etc.) individual endpoints no longer need to implement silent discard for unexpected MCTP packets. This may serve to lower the cost of development and validation of IP blocks within an SoC and also eliminate the associated risk of non-compliant handling of MCTP packets by some IPs (e.g., which could unnecessarily crash the system). Further, enforced bridging may serve to constrain the traffic that might be a security risk to the system. In the case of MCTP, such forced bridging may yield minimal or no performance or functional impact, as MCTP bridges are configured to handle all or a majority of MCTP traffic for a system (e.g., as a worst case or fail safe), minimizing any risk of performance bottlenecks at the bridge(s). In some implementations, MCTP bridging may be enhanced with smart filtering to address various security or even performance concerns. As an example, bridge filtering may be configured to prohibit any endpoint-to-endpoint MCTP traffic with the exception of traffic to and/or from specifically privileged devices (e.g., a BMC, Infrastructure Processing Unit (IPU), Smart NIC, Platform/Primary Root of Trust (PROT), etc.). As another example, a smart filter may be configured on the MCTP bridge to only allow specific types of MCTP traffic (e.g., MCTP traffic of a particular message type (e.g., Security Protocol and Data Model (SPDM) traffic (MCTP Message Type=6)) allowing communication between the endpoints that implement the high standards of security with this protocol). As another example, the bridge may enforce MCTP route-to-root-complex classes of traffic such that no other devices or entities may intercept this traffic. As another example, the bridge may constrain MCTP broadcasts to a specific subset of ports to which the MCTP broadcast packets would be allowed to arrive (allowed to participate in MCTP network), among other examples governed by policies set within the bridge device. In some implementations, configuration of the policies at the MCTP bridge device 635 may be performed at runtime (e.g., by platform firmware, a cloud orchestrator (e.g., via BMC or SmartNIC), or another controller).

As discussed herein, routing circuitry may route all MCTP communication by a single logical component (e.g., MCTP bridge circuitry). The MCTP bridge may implement a routing table that lists all the MCTP-capable endpoints (e.g., SoC IPs) and routes packets to such IPs. In this sense, the MCTP bridge naturally acts a gatekeeper or a supervisor preventing MCTP packets from reaching the IPs that do not support MCTP (e.g., based on the destination device not being included in the routing table) or blocking undesired types of traffic (e.g., implementing policy-based traffic filtering (e.g., based on one or more security policies)). In one example, to prevent MCTP packets from bypassing this supervisor logic and hit unprepared endpoints (e.g., endpoint IP blocks), SoC PCIe MCTP VDM Type 1 routing mechanisms should only allow packets to or from the supervising MCTP bridge. Any other MCTP packets (e.g., not coming from the MCTP bridge or targeting the MCTP bridge) should be silently discarded by the PCIe routing logic. This basically prevents any accidental peer-to-peer MCTP communication not authorized by the MCTP bridge. Such a solution may improve critical system stability and robustness and address security vulnerabilities in a cost effective manner with low validation costs, among other example considerations.

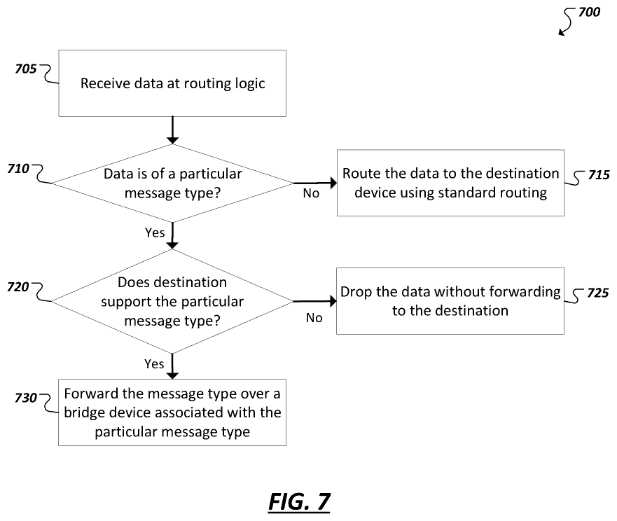

Turning to FIG. 7, a simplified flow diagram 700 is shown illustrating an example technique for more effectively routing data of particular message types (e.g., vendor-defined messages, optionally supported messages, management control messages (e.g., MCTP messages), etc.) within a system. Routing logic of a system (e.g., of a SoC) may receive 705 data (e.g., a packet, flit, message, or other quantum of data) sent on a link (e.g., compliant with an interconnect protocol, such as PCIe, CXL, UCIe, I2C, SMBus, USB, etc.). The routing logic may be implemented in circuitry of a system and may be responsible for routing data on one or more links coupling devices (e.g., IP blocks, cards, etc.) in the system. Specialized routing may be defined for data sent on the link, which includes data of the particular message type. The routing circuitry may determine (at 710) whether the data includes data of the particular message type. If the data does not include data of the particular message type, the routing circuitry may route the data 715 to the destination device (e.g., identified in the data) utilizing standard routing rules. For instance, support of the particular message type may be optional for endpoint devices within the system (e.g., only supported by endpoints with particular functionality (e.g., management controllers), etc.). The protocol governing the link may define that when the particular message type is received by a device which does not support the particular message type, the non-supporting device may silently drop the data (e.g., rather than treat the data as erroneous or unexpected data triggering a more severe reaction (e.g., a reset, crash, etc.)). Rather than forwarding data of the particular message type to non-supporting devices, the routing circuitry may utilize a routing table (e.g., built in runtime as a part of dynamic MCTP address discovery and assignment), which identifies the various endpoint devices within a system, as well as whether each endpoint device supports the particular message type or not. Filtering rules and policies may be defined at runtime or boot time (and populated in the routing table) for specific endpoints, globally, or for specific device classes (e.g., by or with the assistance of platform firmware (e.g., BMC or SmartNIC firmware), or orchestration software or cloud operator, among other examples). As such, the routing circuitry may utilize the routing table to determine (at 720) whether the destination of the data support the particular message type or not. If the routing circuitry determines that the destination device does not support the particular message type, the routing circuitry may drop 725 the data (e.g., the packet) without forwarding the data to the destination. If the routing circuitry determines that the destination does support the particular message type, the routing circuitry may complete the routing of the data to the destination by ensuring that the data is first routed over a bridge device (e.g., a MCTP bridge), which may perform filtering of the data (e.g., to ensure compliance with one or more security policies), data transformation (e.g., associated with bridge routing), among other tasks.

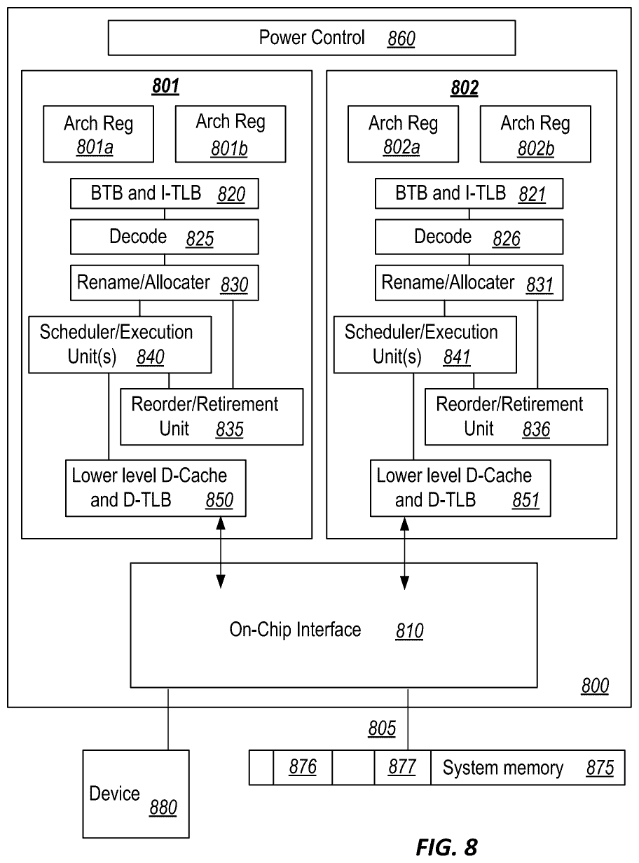

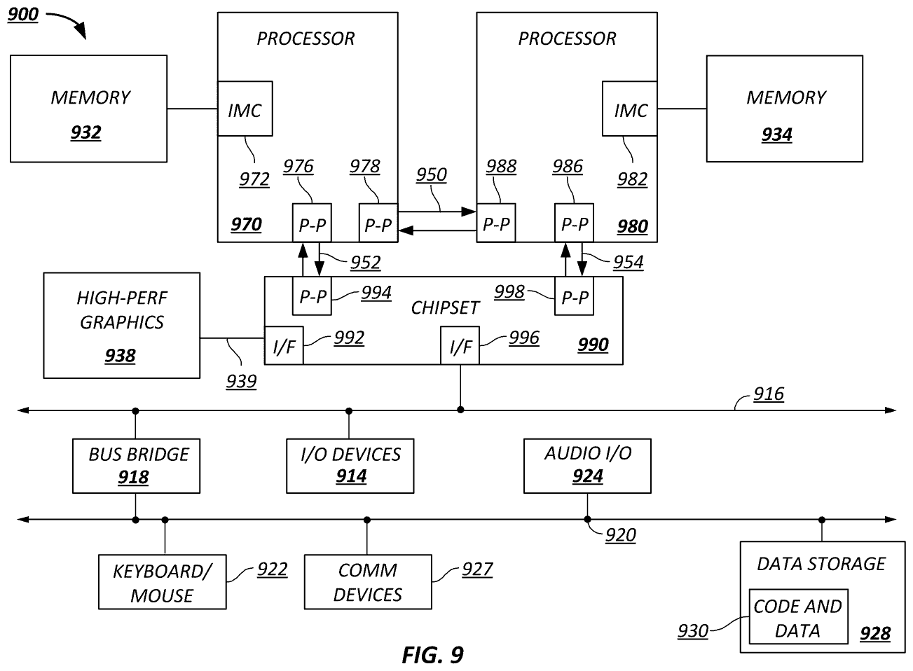

Note that the apparatus’, methods’, and systems described above may be implemented in any electronic device or system as aforementioned. For instance, the computing platforms illustrated in the examples of FIGS. 8 and 9 show connections between various computing devices at least a portion of which may be implemented using corresponding pass-through connector devices with socket connectors compatible with the two connected devices. The computing systems and devices illustrated in FIGS. 8 and 9 may include routing logic and a bridge devices similar to those discussed herein in order to facilitate the routing of data of particular message types (e.g., MCTP messages).

Referring to FIG. 8, an embodiment of a block diagram for a computing system including a multicore processor is depicted. Processor 800 includes any processor or processing device, such as a microprocessor, an embedded processor, a digital signal processor (DSP), a network processor, a handheld processor, an application processor, a co-processor, a system on a chip (SOC), or other device to execute code. Processor 800, in one embodiment, includes at least two cores-core 801 and 802, which may include asymmetric cores or symmetric cores (the illustrated embodiment). However, processor 800 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 800, as illustrated in FIG. 8, includes two cores-core 801 and 802. Here, core 801 and 802 are considered symmetric cores, e.g., cores with the same configurations, functional units, and/or logic. In another embodiment, core 801 includes an out-of-order processor core, while core 802 includes an in-order processor core. However, cores 801 and 802 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (e.g., asymmetric cores), some form of translation, such a binary translation, may be utilized to schedule or execute code on one or both cores. Yet to further the discussion, the functional units illustrated in core 801 are described in further detail below, as the units in core 802 operate in a similar manner in the depicted embodiment.

As depicted, core 801 includes two hardware threads 801a and 801b, which may also be referred to as hardware thread slots 801a and 801b. Therefore, software entities, such as an operating system, in one embodiment potentially view processor 800 as four separate processors, e.g., four logical processors or processing elements capable of executing four software threads concurrently. As alluded to above, a first thread is associated with architecture state registers 801a, a second thread is associated with architecture state registers 801b, a third thread may be associated with architecture state registers 802a, and a fourth thread may be associated with architecture state registers 802b. Here, each of the architecture state registers (1001a, 801b, 802a, and 802b) may be referred to as processing elements, thread slots, or thread units, as described above. As illustrated, architecture state registers 801a are replicated in architecture state registers 801b, so individual architecture states/contexts are capable of being stored for logical processor 801a and logical processor 801b. In core 801, other smaller resources, such as instruction pointers and renaming logic in allocator and renamer block 830 may also be replicated for threads 801a and 801b. Some resources, such as re-order buffers in reorder/retirement unit 835, ILTB 820, load/store buffers, and queues may be shared through partitioning. Other resources, such as general purpose internal registers, page-table base register(s), low-level data-cache and data-TLB 815, execution unit(s) 840, and portions of out-of-order unit 835 are potentially fully shared.

Processor 800 often includes other resources, which may be fully shared, shared through partitioning, or dedicated by/to processing elements. In FIG. 8, an embodiment of a purely exemplary processor with illustrative logical units/resources of a processor is illustrated. Note that a processor may include, or omit, any of these functional units, as well as include any other known functional units, logic, or firmware not depicted. As illustrated, core 801 includes a simplified, representative out-of-order (OOO) processor core. But an in-order processor may be utilized in different embodiments. The OOO core includes a branch target buffer 820 to predict branches to be executed/taken and an instruction-translation buffer (I-TLB) 820 to store address translation entries for instructions.

Core 801 further includes decode module 825 coupled to fetch unit 820 to decode fetched elements. Fetch logic, in one embodiment, includes individual sequencers associated with thread slots 801a, 801b, respectively. Usually core 801 is associated with a first ISA, which defines/specifies instructions executable on processor 800. Often machine code instructions that are part of the first ISA include a portion of the instruction (referred to as an opcode), which references/specifies an instruction or operation to be performed. Decode logic 825 includes circuitry that recognizes these instructions from their opcodes and passes the decoded instructions on in the pipeline for processing as defined by the first ISA. For example, as discussed in more detail below decoders 825, in one embodiment, include logic designed or adapted to recognize specific instructions, such as transactional instruction. As a result of the recognition by decoders 825, the architecture or core 801 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 826, in one embodiment, recognize the same ISA (or a subset thereof). Alternatively, in a heterogeneous core environment, decoders 826 recognize a second ISA (either a subset of the first ISA or a distinct ISA).

In one example, allocator and renamer block 830 includes an allocator to reserve resources, such as register files to store instruction processing results. However, threads 801a and 801b are potentially capable of out-of-order execution, where allocator and renamer block 830 also reserves other resources, such as reorder buffers to track instruction results. Unit 830 may also include a register renamer to rename program/instruction reference registers to other registers internal to processor 800. Reorder/retirement unit 835 includes components, such as the reorder buffers mentioned above, load buffers, and store buffers, to support out-of-order execution and later in-order retirement of instructions executed out-of-order.

Scheduler and execution unit(s) block 840, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 850 are coupled to execution unit(s) 840. The data cache is to store recently used/operated-on elements, such as data operands, which are potentially held in memory coherency states. The D-TLB is to store recent virtual/linear to physical address translations. As a specific example, a processor may include a page table structure to break physical memory into a plurality of virtual pages.

Here, cores 801 and 802 share access to higher-level or further-out cache, such as a second level cache associated with on-chip interface 810. Note that higher-level or further-out refers to cache levels increasing or getting further way from the execution unit(s). In one embodiment, higher-level cache is a last-level data cache—last cache in the memory hierarchy on processor 800—such as a second or third level data cache. However, higher level cache is not so limited, as it may be associated with or include an instruction cache. A trace cache—a type of instruction cache—instead may be coupled after decoder 825 to store recently decoded traces. Here, an instruction potentially refers to a macro-instruction (e.g., a general instruction recognized by the decoders), which may decode into a number of micro-instructions (micro-operations).

In the depicted configuration, processor 800 also includes on-chip interface module 810. Historically, a memory controller, which is described in more detail below, has been included in a computing system external to processor 800. In this scenario, on-chip interface 810 is to communicate with devices external to processor 800, such as system memory 875, a chipset (often including a memory controller hub to connect to memory 875 and an I/O controller hub to connect peripheral devices), a memory controller hub, a northbridge, or other integrated circuit. And in this scenario, bus 805 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 875 may be dedicated to processor 800 or shared with other devices in a system. Common examples of types of memory 875 include DRAM, SRAM, non-volatile memory (NV memory), and other known storage devices. Note that device 880 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 800. For example in one embodiment, a memory controller hub is on the same package and/or die with processor 800. Here, a portion of the core (an on-core portion) 810 includes one or more controller(s) for interfacing with other devices such as memory 875 or a graphics device 880. The configuration including an interconnect and controllers for interfacing with such devices is often referred to as an on-core (or un-core configuration). As an example, on-chip interface 810 includes a ring interconnect for on-chip communication and a high-speed serial point-to-point link 805 for off-chip communication. Yet, in the SOC environment, even more devices, such as the network interface, co-processors, memory 875, graphics processor 880, and any other known computer devices/interface may be integrated on a single die or integrated circuit to provide small form factor with high functionality and low power consumption.

In one embodiment, processor 800 is capable of executing a compiler, optimization, and/or translator code 877 to compile, translate, and/or optimize application code 876 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, e.g., generally where syntactic processing, semantic processing, and some transformation/optimization may take place, and (2) a back-end, e.g., generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

Referring now to FIG. 9, shown is a block diagram of a second system 900 in accordance with an embodiment of the present disclosure. As shown in FIG. 9, multiprocessor system 900 is a point-to-point interconnect system, and includes a first processor 970 and a second processor 980 coupled via a point-to-point interconnect 950. Each of processors 970 and 980 may be some version of a processor. In one embodiment, 952 and 954 are part of a serial, point-to-point coherent interconnect fabric, such as QPI or UPI, among other examples.

While shown with only two processors 970, 980, it is to be understood that the scope of the present disclosure is not so limited. In other embodiments, one or more additional processors may be present in a given processor.

Processors 970 and 980 are shown including integrated memory controller units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 each exchange information with a chipset 990 via individual P-P interfaces 952, 954 using point to point interface circuits 976, 994, 986, 998. Chipset 990 also exchanges information with a high-performance graphics circuit 938 via an interface circuit 992 along a high-performance graphics interconnect 939.

A shared cache (not shown) may be included in either processor or outside of both processors; yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCIe bus or another third generation I/O interconnect bus, although the scope of the present disclosure is not so limited.

As shown in FIG. 9, various I/O devices 914 are coupled to first bus 916, along with a bus bridge 918 which couples first bus 916 to a second bus 920. In one embodiment, second bus 920 includes a low pin count (LPC) bus. Various devices are coupled to second bus 920 including, for example, a keyboard and/or mouse 922, communication devices 927 and a storage unit 928 such as a disk drive or other mass storage device which often includes instructions/code and data 930, in one embodiment. Further, an audio I/O 924 is shown coupled to second bus 920. Note that other architectures are possible, where the included components and interconnect architectures vary. For example, instead of the point-to-point architecture of FIG. 9, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the solutions described above may be implemented in any portion of one or more of the interconnects illustrated or described herein.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. As one example, processor is implemented as a system on a chip (SoC). As a specific illustrative example, processor includes an Intel® Architecture Core™-based processor such as an i3, i5, i7 or another such processor available from Intel Corporation. However, understand that other low power processors such as available from Advanced Micro Devices, Inc. (AMD) of Sunnyvale, CA, a MIPS-based design from MIPS Technologies, Inc. of Sunnyvale, CA, an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: routing circuitry to: receive a message from a first device, where the message is sent from the first device to a second device on a link; determine that the message includes data of a particular message type; determine, from a routing table, that the second device supports the particular message type; and determine a routing of the message to the second device based at least in part on support of the particular message type by the second device, where the message is to be routed over a bridge device associated with the particular message type in the routing of the message to the second device.

Example 2 includes the subject matter of example 1, where the routing circuitry is further to: receive a second message directed to a third device; determine that the second message includes data of the particular message type; determine, from the routing table, that the third device does not support the particular message type; and drop the second message based on the third device not supporting the particular message type, where the second message is dropped to not deliver the second message to the third device.

Example 3 includes the subject matter of any one of examples 1-2, where the particular message type is optionally supported by devices in a system.

Example 4 includes the subject matter of any one of examples 1-3, where the particular message type includes a management controller message type.

Example 5 includes the subject matter of example 4, where the particular message type includes messages defined according to Management Component Transport Protocol (MCTP).

Example 6 includes the subject matter of example 5, where the link is compliant with an interconnect protocol and MCTP messages are carried over the interconnect protocol.

Example 7 includes the subject matter of example 6, where the interconnect protocol includes one of Peripheral Component Interconnect Express (PCIe), SMBus, I2C, or Compute Express Link (CXL).

Example 8 includes the subject matter of any one of examples 1-7, where the routing circuitry is further to: receive a second message directed to a particular device; determine that the second message does not include data of the particular message type; and route the second message to the particular device, where the second message is not routed over the bridge device.

Example 9 includes the subject matter of any one of examples 1-8, including a system on chip (SoC), where the SoC includes the routing circuitry, the bridge device, and at least one of the first device or the second device.

Example 10 includes the subject matter of example 9, where at least one of the first device or the second device includes an IP block on the SoC.

Example 11 includes the subject matter of any one of examples 9-10, where at least one of the first device or the second device includes a device external to the SoC and to couple to the SoC via the link.

Example 12 is a method including: receiving a management control message to be routed from a first device to a second device in a system; determining that the management control message includes management control data; determining whether the second device supports management control messages; determining whether to forward the management control message to the second device based on whether the second device supports management control messages; and routing management control messages to destination devices within the system over a bridge device associated with the management control messages.

Example 13 includes the subject matter of example 12, where the management control messages include Management Component Transport Protocol (MCTP) packets.

Example 14 includes the subject matter of example 13, dropping the management control message based on a determination that the second device does not support MCTP.

Example 15 includes the subject matter of any one of examples 12-14, further including filtering the management control message at the bridge device based on a policy, where filtering the management control message causes the management control message to be dropped at the bridge device and not delivered to the second device.

Example 16 includes the subject matter of example 15, where the policy includes a security policy.

Example 17 includes the subject matter of any one of examples 12-16, where the method is performed by the apparatus of any one of examples 1-11.

Example 18 is a system including means to perform the method of any one of examples 12-17.

Example 19 is a system including: routing circuitry to: receive a message from a first device, where the message is sent from the first device to a second device on a link; determine that the message includes data of a management control message; determine, from a routing table, that the second device supports management control messages; and route the message to the second device based at least in part on support of the management control messages by the second device; and a bridge device associated with the management control messages, where the bridge device is to apply filters to management control messages, and the routing circuitry is to route management control messages over the bridge device.

Example 20 includes the subject matter of example 19, further including the second device, where the second device includes a management controller and supports the management control messages.

Example 21 includes the subject matter of any one of examples 19-20, where the protocol circuitry is to drop management control messages bound for devices which do not support the management control messages.

Example 22 includes the subject matter of any one of examples 19-21, where the routing circuitry is further to: receive a second message directed to a third device; determine that the second message includes data of the particular message type; determine, from the routing table, that the third device does not support the particular message type; and drop the second message based on the third device not supporting the particular message type, where the second message is dropped to not deliver the second message to the third device.

Example 23 includes the subject matter of any one of examples 19-22, where the particular message type is optionally supported by devices in a system.

Example 24 includes the subject matter of any one of examples 19-23, where the particular message type includes a management controller message type.

Example 25 includes the subject matter of any one of examples 19-24, where the routing circuitry is further to: receive a second message directed to a particular device; determine that the second message does not include data of the particular message type; and route the second message to the particular device, where the second message is not routed over the bridge device.

Example 26 includes the subject matter of any one of examples 19-25, including a system on chip (SoC), where the SoC includes the routing circuitry, the bridge device, and at least one of the first device or the second device.

Example 27 includes the subject matter of example 26, where at least one of the first device or the second device includes an IP block on the SoC.

Example 28 includes the subject matter of any one of examples 26-27, where at least one of the first device or the second device includes a device external to the SoC and to couple to the SoC via the link.

Example 29 includes the subject matter of any one of examples 19-28, where the management control messages include Management Component Transport Protocol (MCTP) packets.

Example 30 includes the subject matter of example 29, where the link is compliant with an interconnect protocol and MCTP messages are carried over the interconnect protocol.

Example 31 includes the subject matter of example 30, where the interconnect protocol includes one of Peripheral Component Interconnect Express (PCIe), SMBus, I2C, or Compute Express Link (CXL).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
routing circuitry to:
receive a message from a first device, wherein the message is sent from the first device to a second device on a link;
determine that the message comprises data of a particular message type;
determine, from a routing table, that the second device supports the particular message type; and
determine a routing of the message to the second device based at least in part on support of the particular message type by the second device, wherein the message is to be routed over a bridge device associated with the particular message type in the routing of the message to the second device.

2. The apparatus of claim 1, wherein the routing circuitry is further to:
receive a second message directed to a third device;
determine that the second message comprises data of the particular message type;
determine, from the routing table, that the third device does not support the particular message type; and
drop the second message based on the third device not supporting the particular message type, wherein the second message is dropped to not deliver the second message to the third device.

3. The apparatus of claim 1, wherein the particular message type is optionally supported by devices in a system.

4. The apparatus of claim 1, wherein the particular message type comprises a management controller message type.

5. The apparatus of claim 4, wherein the particular message type comprises messages defined according to Management Component Transport Protocol (MCTP).

6. The apparatus of claim 5, wherein the link is compliant with an interconnect protocol and MCTP messages are carried over the interconnect protocol.

7. The apparatus of claim 6, wherein the interconnect protocol comprises one of Peripheral Component Interconnect Express (PCIe), SMBus, I2C, NVLink, or Compute Express Link (CXL).

8. The apparatus of claim 1, wherein the routing circuitry is further to:
receive a second message directed to a particular device;
determine that the second message does not include data of the particular message type;
route the second message to the particular device, wherein the second message is not routed over the bridge device.

9. The apparatus of claim 1, comprising a system on chip (SoC), wherein the SoC comprises the routing circuitry, the bridge device, and at least one of the first device or the second device.

10. The apparatus of claim 9, wherein at least one of the first device or the second device comprises an IP block on the SoC.

11. The apparatus of claim 9, wherein at least one of the first device or the second device comprises a device external to the SoC and to couple to the SoC via the link.

12. A method comprising:
receiving a management control message to be routed from a first device to a second device in a system;
determining that the management control message comprises management control data;
determining whether the second device supports management control messages;
determining whether to forward the management control message to the second device based on whether the second device supports management control messages; and
routing management control messages to destination devices within the system over a bridge device associated with the management control messages.

13. The method of claim 12, wherein the management control messages comprise Management Component Transport Protocol (MCTP) packets.

14. The method of claim 13, dropping the management control message based on a determination that the second device does not support MCTP.

15. The method of claim 12, further comprising filtering the management control message at the bridge device based on a policy, wherein filtering the management control message causes the management control message to be dropped at the bridge device and not delivered to the second device.

16. The method of claim 15, wherein the policy comprises a security policy.

17. A system comprising:
routing circuitry to:
receive a message from a first device, wherein the message is sent from the first device to a second device on a link;
determine that the message comprises data of a management control message;
determine, from a routing table, that the second device supports management control messages; and
route the message to the second device based at least in part on support of the management control messages by the second device; and
a bridge device associated with the management control messages, wherein the bridge device is to apply filters to management control messages, and the routing circuitry is to route management control messages over the bridge device.

18. The system of claim 17, further comprising the second device, wherein the second device comprises a management controller and supports the management control messages.

19. The system of claim 17, wherein the management control messages comprise Management Component Transport Protocol (MCTP) packets.

20. The system of claim 17, wherein the protocol circuitry is to drop management control messages bound for devices which do not support the management control messages.
